(19) United States
(12) Patent Application Publication
(10) Pub. No.: US 2009/0202314 A1
(43) Pub. Date: Aug. 13, 2009

(54) BORING TOOL AND HOLDER FOR THE SAME

(75) Inventors: Yasuhiko Okita, Hyogo (JP); Takashi Kanda, Hyogo (JP); Naoki Sakata, Hyogo (JP); Shinya Uesaka, Hyogo (JP); Tomohiro Fukaya, Hyogo (JP); Koichi Sakikawa, Hyogo (JP)

Correspondence Address: MCDERMOTT WILL & EMERY LLP, 600 13TH STREET, N.W., WASHINGTON, DC, 20005-3096, US

(73) Assignee: SUMITOMO ELECTRIC HARDMETAL CORP., HYOGO (JP)

(21) Appl. No.: 12/307,316

(22) PCT Filed: Apr. 11, 2007
(86) PCT No.: PCT/JP2007/057961

§ 371 Date: Jan. 2, 2009

(30) Foreign Application Priority Data
Jul. 3, 2006 (JP) 2006-182957

(51) Int. Cl. B23B 51/00; B26D 3/00

(52) U.S. Cl. 408/227; 407/107

(57) ABSTRACT

One object of the present invention is to increase stability for fixing a cutting tool with a holder formed of a sleeve, and to improve machining accuracy of a boring tool using the holder and prevent chipping of a cutting edge. In a holder for a boring tool holding a bar-shaped cutting tool by receiving it in a center hole in a sleeve and clamping it with clamp means, the sleeve is provided with a slit cutting a region from the center hole in the sleeve to an outer periphery surface thereof lengthwise from a front end to a longitudinal partway portion of the sleeve, and is further provided with a fastener tightening a slit-formed portion of the sleeve to change an inner diameter of the center hole.

### TECHNICAL FIELD

The present invention relates to a boring tool utilized for boring small parts, and a holder for the boring tool formed of a sleeve.

### BACKGROUND ART

A small diameter boring tool suitable for boring an extremely small inner diameter is disclosed in Patent Document 1 described below.

The boring tool disclosed in Japanese Patent No. 2784530 (Patent Document 1) is formed by combining a bar-shaped tip with a sleeve, and has a structure that a shank portion of the bar-shaped tip is inserted into a center hole in the sleeve, and the shank portion is fastened with screws screwed into a holder to hold the bar-shaped tip in the sleeve. The center hole in the sleeve is formed as a through hole. The bar-shaped tip has a chamfered portion on the outer periphery of its portion to be inserted into the center hole in the sleeve, and a space produced between an inner surface of the center hole and the chamfered portion on the outer periphery of the tip is used as a passage for a coolant.

A similar boring tool is also described in Japanese Patent No. 3330085 (Patent Document 2) as a conventional technique.

### Patent Document 1: Japanese Patent No. 2784530

### Patent Document 2: Japanese Patent No. 3330085

### DISCLOSURE OF THE INVENTION

### Problems to be Solved by the Invention

In the boring tool disclosed in Patent Document 1, the bar-shaped tip is clamped using a method of fastening the tip in one direction with two screws screwed into the sleeve. With this method, however, the tip fastened with the screws is in line contact with the inner surface of the hole, resulting in unstable fixation of the tip. Between the bar-shaped tip and the inner surface of the center hole in the sleeve, there are gaps for inserting and removing the tip. Of the gaps, the gap in a fastening direction is eliminated by tightening the screws, whereas the gap in a direction perpendicular to the fastening direction remains even after the fixation, and allows wobbling of the tip. Therefore, the tip is held insufficiently, causing a reduction in rigidity against a force exerted in the direction perpendicular to the fastening direction. As a result, so-called “chatter” of the boring tool occurs during machining, causing chipping of a cutting edge.

Recently, there is an increasing tendency that a boring tool using sintered diamond or sintered CBN (cubic boron nitride) as a material for a cutting edge is employed to machine a material with a high hardness. In the machining of a material with a high hardness using a boring tool of this type, cutting resistance is increased, and chatter leading to deterioration of machining accuracy or chipping of a cutting edge is particularly likely to occur.

In the boring tool disclosed in Patent Document 2 as a conventional technique, it seems that the tip is fixed using a method identical to the method used for the boring tool of Patent Document 1, although Patent Document 2 does not describe the method of fixing the tip. Accordingly, the boring tool of Patent Document 2 has the same problem as that of the boring tool of Patent Document 1.

One object of the present invention is to increase stability for fixing a cutting tool with a holder formed of a sleeve as disclosed in Patent Documents 1 and 2, and to improve machining accuracy of a boring tool using the holder and prevent chipping of a cutting edge.

### Means for Solving the Problems

To solve the aforementioned problems, in the present invention, in a holder for a boring tool holding a bar-shaped cutting tool by receiving the bar-shaped cutting tool in a center hole in a sleeve and clamping it with clamp means, the sleeve is provided with a slit cutting a region from the center hole in the sleeve to an outer periphery surface thereof lengthwise from a front end to a longitudinal partway portion of the sleeve, and is further provided with a fastener tightening a slit-formed portion of the sleeve to change an inner diameter of the center hole.

Preferable modes of the holder will be listed below.

(1) The slit is provided at one side position of the sleeve to traverse the sleeve in a radial direction.
(2) A length l1 from a center of the center hole in the sleeve to a center of an installation point of the fastener and a length l2 from the center of the center hole to an outer end of the slit in a radial direction are set to satisfy a condition 20%<l1/l2<80%.
(3) At least one set screw that comes into contact with a shank portion of the bar-shaped cutting tool to fasten the shank portion in a direction perpendicular to an axis is provided as the clamp means.
(4) The center hole has a gripping surface gripping the bar-shaped cutting tool with a surface roughness of not less than 0.5 μm and not more than 12.5 μm in a ten point height of roughness profile.
(5) The sleeve has different outer diameters in a front end portion and in a rear portion thereof. Specifically, the front end portion of the sleeve has an outer diameter larger or smaller than an outer diameter of the rear portion of the sleeve.

The present invention also provides a boring tool formed by holding with the holder of the present invention described above a bar-shaped cutting tool including a front end portion formed of sintered diamond or sintered CBN provided with a cutting edge.

### EFFECTS OF THE INVENTION

In the holder of the present invention, when the slit-formed portion of the sleeve is tightened, the inner diameter of the center hole in the sleeve is reduced. Thereby, an inner surface of the center hole is attached firmly to the outer periphery of the shank portion of the bar-shaped cutting tool over a wide range, and a gap that allows wobbling of the boring tool is not formed between the inner surface and the bar-shaped cutting tool. As a result, chatter of the bar-shaped cutting tool during machining is reduced, suppressing reduction in machining accuracy and chipping of a cutting edge due to the chatter.

In the holder having the slit provided at one side position of the sleeve, the sleeve is cut in a circumferential direction at only one position on the periphery of the center hole, suppressing a reduction in rigidity of the sleeve due to the provision of the slit. In addition, only one set of fasteners is required to tighten the slit-formed portion of the sleeve. Further, a slit provided to traverse the sleeve in a radial direction when seen from an end surface of the sleeve can be machined easily.

Further, in the holder in which the fastener tightening the slit-formed portion of the sleeve is installed at a position satisfying a condition 20%<l1/l2<80%, the slit-formed portion is tightened at an appropriate position, and force for holding the bar-shaped cutting tool (holding force) and holding stability are increased when compared with the case where the condition is not satisfied, which allows easy fixation of the bar-shaped cutting tool.

Furthermore, since tightening by the fastener tightening the slit-formed portion of the sleeve is not sufficient to prevent the bar-shaped cutting tool from being rotated or moved in an axial direction inside the center hole, the holder of the present invention is provided with clamp means fixing the bar-shaped cutting tool, in addition to the fastener. In the holder provided with at least one set screw that comes into contact with a shank portion of the bar-shaped cutting tool to fasten the shank portion in a direction perpendicular to an axis as the clamp means, the bar-shaped cutting tool is directly fastened and thus the cutting tool is fixed reliably. Herein, “a direction perpendicular to an axis” refers to a direction perpendicular to an axial direction of the shank portion of the bar-shaped cutting tool, and “to fasten the shank portion in a direction perpendicular to an axis” refers to placing the set screw such that an axial direction of the set screw is set along the direction perpendicular to the axis, pressing a front end of the set screw against the shank portion, and thereby fixing the shank portion.

In addition, in the holder in which the center hole in the sleeve has an inner surface (gripping surface) with a surface roughness of not less than 0.5 μm and not more than 12.5 μm in a ten point height of roughness profile, a contact area with the bar-shaped cutting tool is increased, and thereby the holding force for holding the cutting tool caused by friction is increased to further stabilize the fixation of the cutting tool.

Further, with the holder in which the front end portion of the sleeve has an outer diameter larger than an outer diameter of the rear portion thereof, when the holder is supported by a tool rest of a working machine, the sleeve can be inserted into the tool rest for a constant length, utilizing a large diameter portion at the front end of the sleeve. In contrast, with the holder in which the front end portion of the sleeve has an outer diameter smaller than an outer diameter of the rear portion thereof, machining restrictions determined by the size of a workpiece are eased, and the front end portion of the sleeve is allowed to enter an inner side of a workpiece to perform machining, depending on the size of a front end diameter of the sleeve. When such machining can be performed, the amount of protrusion of the cutting tool from the front end of the sleeve can be reduced to suppress chatter of the boring tool during machining more effectively.

In the boring tool of the present invention, machining stability and machining accuracy are improved and the cutting tool has an improved life by virtue of the function and effect of the holder described above.

### BRIEF DESCRIPTION OF THE DRAWINGS

FIG. 1 is a perspective view showing an example of a holder of the present invention.

FIG. 2 is a plan view of the holder of FIG. 1.

FIG. 3 is a front view of the holder of FIG. 1.

FIG. 4 is a perspective view of a boring tool using the holder of FIG. 1.

FIG. 5 is a cross sectional view at a position along a line V-V in FIG. 4.

FIG. 6 is a cross sectional view at a position along a line VI-VI in FIG. 4.

FIG. 7 is a perspective view showing another embodiment of the holder of the present invention.

### DESCRIPTION OF THE REFERENCE SIGNS

1: holder, 2: sleeve, 2a: large diameter portion, 2b: small diameter portion, 2c: stepped portion, 3: clamp means, 4: fastener, 5: chamfered portion, 6: center hole, 7: slit, 8, 9: tapped hole, 10: bar-shaped cutting tool, 11: shank portion, 12: head portion, 13: hard sintered body, 14: cutting edge, 15: rake face, 16: chamfered portion, 20: boring tool.

### BEST MODES FOR CARRYING OUT THE INVENTION

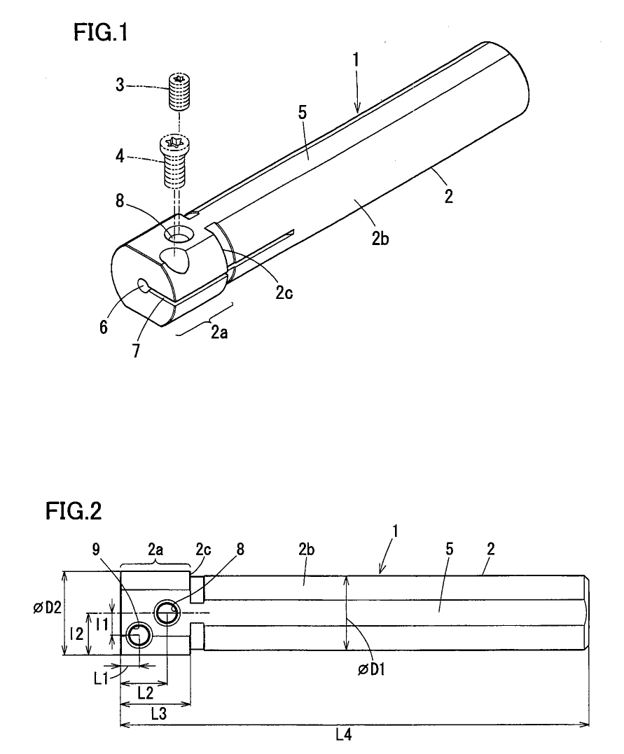

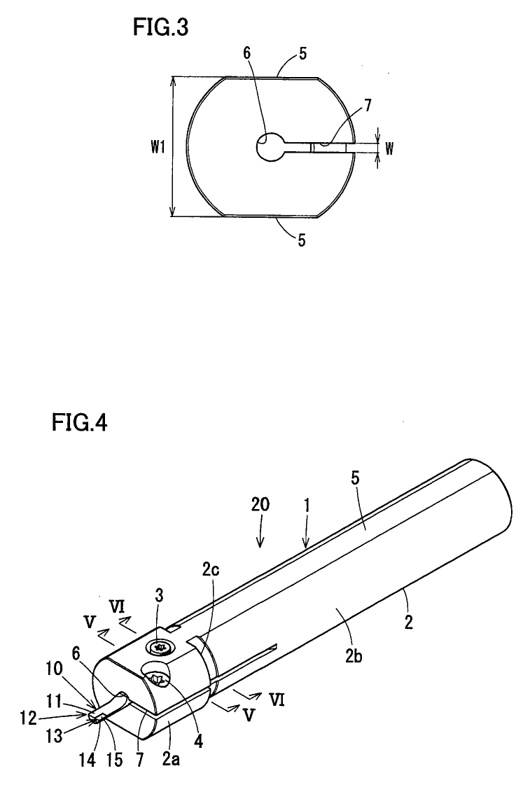

Hereinafter, an embodiment of a holder of the present invention and a boring tool using the same will be described with reference to FIGS. 1 to 7 of the attached drawings. FIG. 1 is a perspective view showing an example of the holder, FIG. 2 is a plan view of the holder, and FIG. 3 is a front view of the holder. A holder 1 illustrated includes a sleeve 2, clamp means 3, and a fastener 4.

As shown in FIGS. 1 and 2, sleeve 2 is a stepped sleeve having a large diameter portion 2a on a front end side, and a rear portion to be held by a tool rest of a working machine formed as a small diameter portion 2b. Sleeve 2 is provided with chamfered portions 5 having a width across flat on the outer periphery thereof to be sandwiched by the tool rest of the working machine. Sleeve 2 is also provided with a center hole 6 passing through in an axial direction at the center thereof. Further, a region from center hole 6 in a front end side portion of sleeve 2 to its outer periphery surface is cut lengthwise by a slit 7 provided to traverse the region in a radial direction when seen from an end surface shown in FIG. 3. Slit 7 is provided in a range from a front end to a longitudinal partway portion of sleeve 2 to cut the periphery of center hole 6 in sleeve 2 at one position in the radial direction.

Center hole 6 is a hole having a diameter that is substantially identical to an outer diameter of a shank portion 11 of a bar-shaped cutting tool 10 shown in FIGS. 4 to 6 (i.e., a hole slightly larger than the outer diameter of the shank portion for smooth insertion and removal of shank portion 11). Center hole 6 has an inner surface (a gripping surface gripping the bar-shaped cutting tool) formed to have a surface roughness of not less than 0.5 μm and not more than 12.5 μm, more preferably, not less than 0.5 μm and not more than 3.2 μm, in a ten point height of roughness profile. Herein, the ten point height of roughness profile (Rzjis) is determined as the sum of an average of heights of the five highest peaks and an average of depths of the five deepest valleys in a roughness curve having a reference length (unit: μm), according to Appendix 1 of JIS (Japan Industrial Standard) B0601-2001.

Clamp means 3 is provided at a position that is located upside when sleeve 2 is used as the holder. Clamp means 3 illustrated is a set screw screwed into a tapped hole 8 (see FIG. 6) passing through sleeve 2 in the radial direction. A front end of clamp means 3 enters center hole 6 in the sleeve and directly fastens the shank portion of the bar-shaped cutting tool inserted into center hole 6, thereby pressing the shank portion against the inner surface of center hole 6. In the holder illustrated, a direction in which the cutting tool is fastened by clamp means 3 coincides with a direction in which a main component force is exerted when the boring tool is in use, which is highly effective in preventing the cutting tool from being moved by the main component force. In the holder of the present invention, one clamp means 3 is satisfactory as the cutting tool is also gripped by center hole 6. However, the number of clamp means 3 is not limited to one, and a plurality of clamp means 3 may be provided.

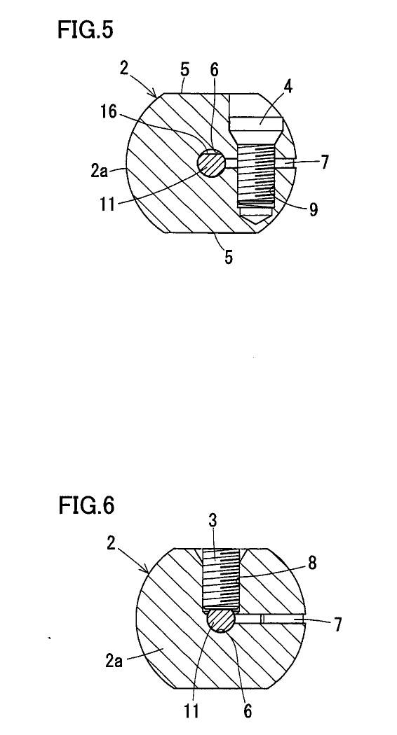

Fastener 4 is provided to tighten a slit-formed portion of sleeve 2, and herein a countersunk head screw is used. When fastener 4 is screwed into a tapped hole 9 shown in FIG. 5 and tightened, portions of sleeve 2 facing each other with slit 7 interposed therebetween are pulled toward each other, and thereby an inner diameter of center hole 6 is reduced.

To tighten the slit-formed portion at an appropriate position, fastener 4 is installed at a position satisfying a condition 20%<l1/l2<80%, where l1 represents a length from a center of center hole 6 to a center of an installation point of the fastener (see FIG. 2), and l2 represents a length from the center of center hole 6 to an outer end of slit 7 in the radial direction. Thereby, the slit-formed portion is tightened at an appropriate position, providing excellent holding force and stability for holding the bar-shaped cutting tool.

FIGS. 4 to 6 show a boring tool 20 formed by holding bar-shaped cutting tool (bar-shaped tip) 10 with holder 1 described above. Bar-shaped cutting tool 10 has a head portion 12 at a front end of shank portion 11. Head portion 12 has a portion formed of a hard sintered body (sintered diamond or sintered CBN) 13, and hard sintered body 13 is provided with a cutting edge 14 and a rake face 15. Further, a chamfered portion 16 is provided on the outer periphery of the shank portion along the entire length of the shank portion. Chamfered portion 16 is provided to be fastened by clamp means 3 and thereby reliably prevent rotation of bar-shaped cutting tool 10.

Shank portion 11 of bar-shaped cutting tool 10 is inserted into center hole 6 in holder 1. When fastener 4 is tightened in this state, the diameter of center hole 6 is reduced, and the inner surface of center hole 6 is attached firmly to the outer periphery of shank portion 11. Further, by tightening clamp means 3, bar-shaped cutting tool 10 is prevented from rotating and fixed, and a gap on the outer periphery of the shank portion that allows wobbling of bar-shaped cutting tool 10 is eliminated, effectively suppressing chatter during machining.

In boring tool 20 illustrated, a stepped portion 2c between large diameter portion 2a and small diameter portion 2b of sleeve 2 can be used as a positioning stopper. Thereby, when boring tool 20 is set in the tool rest of the working machine, sleeve 2 can be inserted into the tool rest for a constant length, and thus positioning is facilitated.

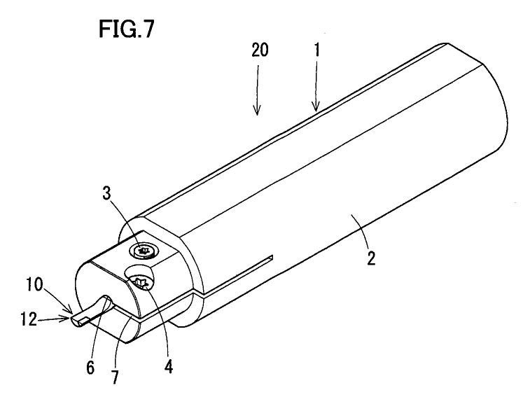

Holder 1 in which the front end portion of sleeve 2 has an outer diameter smaller than an outer diameter of the rear portion thereof as shown in FIG. 7 is also conceivable. In the holder of this structure, the front end portion of sleeve 2 is set smaller than a diameter of a bore in a workpiece, and thus the front end portion can enter the bore in the workpiece to perform machining. Thereby, the amount of protrusion of the cutting tool from the front end of sleeve 2 can be reduced to suppress chatter of the boring tool during machining more effectively.

It has been found that holder 1 of FIG. 1 stably holds the cutting tool and is particularly preferable when employing sleeve 2 in which each portion in FIG. 2 has dimensions set as described below, as a result of studying appropriate installation points of clamp means 3 and fastener 4, an appropriate length of slit 7, an appropriate width of slit 7, and the like:

(1) At least one clamp means 3 is provided such that its center is located at not less than 2 mm and not more than 40 mm from the front end of sleeve 2;
(2) At least one fastener 4 is provided such that its center is located at not less than 5 mm and not more than 50 mm from the front end of sleeve 2;
(3) Slit 7 has a length of not less than 5 mm and not more than 50 mm in the axial direction of the sleeve; and
(4) Slit 7 has a width W (see FIG. 3) of not less than 0.2 mm and not more than 3 mm.

Specifications of sleeve 2

material: heat-treated steel (JIS SCM440), an overall length L4=100 mm, a length L3 of large diameter portion 2a=20 mm, an outer diameter φD2 of large diameter portion 2a=18 mm, an outer diameter φD1 of small diameter portion 2b=16 mm, a width across flat W1 of large diameter portion 2a=15 mm, the inner diameter of center hole 6=φ3.0 mm

In the holder of FIGS. 1 to 6, a distance L2 from the front end of sleeve 2 to the center of clamp means 3 is set to 16 mm, and a distance L1 from the front end of sleeve 2 to the center of fastener 4 is set to 4 mm, under the above specifications.

Hereinafter, performance evaluation tests conducted for the holder of the present invention will be described.

Evaluation Test 1

A cutting test was conducted under the conditions described below, using a boring tool formed by combining a bar-shaped cutting tool with the holder of the present invention using the sleeve with the specifications described in the above-mentioned paragraph, and a boring tool formed by combining a bar-shaped cutting tool with a conventional holder in which the bar-shaped cutting tool (bar-shaped tip) was fixed (clamped) in a sleeve without a slit using a method of fastening the cutting tool in one direction with a screw screwed into the sleeve. The test was conducted with a feed rate changed, to determine the presence or absence of chatter of the boring tool during machining. Table 1 shows the results thereof.

Cutting Conditions

work material: carburized JIS SCM415 (Rockwell C-scale Hardness (HRC) 60)

boring diameter: 4.1 mm

cutting speed: 50 m/min

cut amount: 0.02 mm

TABLE 1

| Feed rate (mm/rev) | 0.005 | 0.01 | 0.02 | 0.04 |
|---|---|---|---|---|
| Boring tool using the holder | No | No | No | No |
| of the present invention | chatter | chatter | chatter | chatter |
| Boring tool using the | No | Chatter | Chatter | Chatter |
| conventional holder | chatter | occurred | occurred | occurred |

In this test, the boring tool using the sleeve holder of the present invention had high holding force and stability for holding the bar-shaped cutting tool, and no chatter occurred even when the feed rate was increased. In contrast, in the boring tool using the conventional sleeve holder, chatter occurred when the feed rate was increased.

Evaluation Test 2

Cutting was conducted under the conditions described below, using the boring tool employing the holder of the present invention and the boring tool employing the conventional holder identical to those used in Evaluation Test 1, with an amount of protrusion L of a cutting edge of the bar-shaped cutting tool from the front end of the holder (a ratio thereof to a diameter D of the bar-shaped cutting tool) changed, to determine the presence or absence of chatter of the boring tool on this occasion. Table 2 shows the results thereof.

Cutting Conditions

work material: carburized JIS SCM415 (Rockwell C-scale Hardness (HRC) 60)

boring diameter: 4.1 mm

cutting speed: 70 m/min

feed rate: 0.002 mm/rev

cut amount: 0.02 mm

TABLE 2

| Amount of protrusion (L/D) | 2 | 2.5 | 3 | 3.5 |
|---|---|---|---|---|
| Boring tool using the holder | No | No | No | No |
| of the present invention | chatter | chatter | chatter | chatter |
| Boring tool using the | No | Chatter | Chatter | Chatter |
| conventional holder | chatter | occurred | occurred | occurred |

L/D: the amount of protrusion/the diameter of the bar-shaped tool

In this test, the boring tool using the sleeve holder of the present invention had no chatter even when the value of L/D was increased to 3.5. In contrast, in the boring tool using the conventional sleeve holder, chatter occurred when the ratio L/D was increased to more than 2. It is to be noted that a boring tool for which the value of L/D can be set high can also be used to machine a bore with a deeper depth relative to a diameter thereof, and thus the boring tool can be used for wider applications.

As can be seen from Evaluation tests 1 and 2, when the holder of the present invention having a sleeve with a slit is used, holding force and stability for holding the bar-shaped cutting tool by the holder are increased, suppressing chatter of the boring tool during machining. Thereby, chipping of a cutting edge due to the chatter is reduced, and machining accuracy is improved.

1. A holder for a boring tool holding a bar-shaped cutting tool with a sleeve by receiving a shank portion of said bar-shaped cutting tool in a center hole in said sleeve and clamping the shank portion with clamp means,
wherein said sleeve is provided with a slit cutting a region from said center hole in the sleeve to an outer periphery surface thereof lengthwise from a front end to a longitudinal partway portion of the sleeve, and is further provided with a fastener tightening a slit-formed portion of the sleeve to change an inner diameter of said center hole.

2. The holder for a boring tool according to claim 1, wherein said slit is provided at one side position of said sleeve to traverse the sleeve in a radial direction.

3. The holder for a boring tool according to claim 1, wherein a length l1 from a center of said center hole to a center of an installation point of said fastener and a length l2 from the center of said center hole to an outer end of said slit in a radial direction are set to satisfy a condition 20%≦l1/l2≦80%.

4. The holder for a boring tool according to claim 1, wherein at least one set screw that comes into contact with the shank portion of said bar-shaped cutting tool to fasten the shank portion in a direction perpendicular to an axis is provided as said clamp means.

5. The holder for a boring tool according to claim 1, wherein said center hole has a gripping surface gripping said bar-shaped cutting tool with a surface roughness of not less than 0.5 μm and not more than 12.5 μm in a ten point height of roughness profile.

6. The holder for a boring tool according to claim 1, wherein said sleeve has different outer diameters in a front end portion and in a rear portion thereof.

7. A boring tool holding with the holder according to claim 1 a bar-shaped cutting tool including a head portion having a portion formed of a hard sintered body of diamond or CBN provided with a cutting edge.
